(19) United States
(12) Patent Application Publication
(10) Pub. No.: US 2024/0202900 A1
(43) Pub. Date: Jun. 20, 2024

(54) DISPLAY CONTROL APPARATUS, DISPLAY CONTROL METHOD, AND DISPLAY CONTROL PROGRAM

(71) Applicant: FUJIFILM Corporation, Tokyo (JP)

(72) Inventors: Morito NISEKI, Saitama-shi (JP); Yuta ABE, Saitama-shi (JP); Tomoharu SHIMADA, Saitama-shi (JP); Atsushi ONODA, Saitama-shi (JP); Tetsuro ASHIDA, Saitama-shi (JP)

(73) Assignee: FUJIFILM Corporation, Tokyo (JP)

(21) Appl. No.: 18/588,789

(22) Filed: Feb. 27, 2024

Related U.S. Application Data
(63) Continuation of application No. PCT/JP2022/022700, filed on Jun. 6, 2022.

(30) Foreign Application Priority Data
Aug. 31, 2021 (JP) 2021-142008

(51) Int. Cl. G06T 7/00; G06T 1/00; G09G 3/20

(52) U.S. Cl. CPC G06T 7/0002; G06T 1/00; G06T 7/97; G09G 3/20; G09G 2320/0686; G09G 2354/00; G09G 2356/00

(57) ABSTRACT

A display control apparatus includes: a processor; and a memory, and the processor is configured to acquire a plurality of image data, perform control of displaying, in a first region of a display, a first image data group including a plurality of first image data selected from the plurality of acquired image data based on a first criterion, perform control of displaying, in a second region of the display, selected image data that is at least one image data selected from the first image data group, and perform control of displaying, in a third region of the display, a second image data group including second image data selected from the plurality of image data based on a second criterion based on specific image data that is at least one of the selected image data.

### CROSS REFERENCE TO RELATED APPLICATION

This is a continuation of International Application No. PCT/JP2022/022700 filed on Jun. 6, 2022, and claims priority from Japanese Patent Application No. 2021-142008 filed on Aug. 31, 2021, the entire disclosures of which are incorporated herein by reference.

### BACKGROUND OF THE INVENTION

### 1. Field of the Invention

The present invention relates to a display control apparatus, a display control method, and a computer readable medium storing a display control program.

### 2. Description of the Related Art

JP2015-069598A describes a person image display control apparatus. The person image display control apparatus comprises representative person image display control means, representative person image selection means, and person image display control means. The representative person image display control means controls a display device to display a representative person image on a display screen. The representative person image is an image representing a person included in a large number of person images. The representative person image selection means selects a representative person image as a display target among the representative person images. The person image display control means controls the display device to display a person image including the person represented by the representative person image selected by the representative person image selection means among a large number of person images on the display screen.

JP2006-146755A describes a display control apparatus that performs control of displaying a plurality of images on a screen. The display control apparatus comprises classification means, region display control means, and image display control means. The classification means classifies a plurality of input image data into a plurality of groups based on feature information added to the image data, respectively. The region display control means displays a display region for displaying characteristics of each group for two or more groups among the plurality of classified groups on one screen at once. The image display control means sequentially displays one image as a display target among the plurality of images respectively represented by the plurality of image data of the group in each display region of the two or more groups while switching the images at a predetermined timing.

### SUMMARY OF THE INVENTION

An object of the present invention is to support work of selecting a desired image from among a plurality of images.

An aspect of the present invention relates to a display control apparatus comprising: a processor; and a memory, in which the processor acquires a plurality of image data, performs control of displaying, in a first region of a display, a first image data group including a plurality of first image data selected from the plurality of acquired image data based on a first criterion, performs control of displaying, in a second region of the display, selected image data that is at least one image data selected from the first image data group, and performs control of displaying, in a third region of the display, a second image data group including second image data selected from the plurality of image data based on a second criterion based on specific image data that is at least one of the selected image data.

Another aspect of the present invention relates to a display control apparatus comprising: a processor; and a memory, in which the processor acquires a plurality of image data, performs control of displaying, in a first region of a display, a first image data group including representative image data of each group obtained by grouping the plurality of acquired image data, performs control of displaying, in a second region of the display, selected image data that is at least one image data selected from the first image data group, and performs control of displaying, in a third region of the display, a second image data group that is image data of the group including specific image data that is at least one image data of the selected image data.

Still another aspect of the present invention relates to a display control method comprising: acquiring a plurality of image data; performing control of displaying, in a first region of a display, a first image data group including a plurality of first image data selected from the plurality of acquired image data based on a first criterion; performing control of displaying, in a second region of the display, selected image data that is at least one image data selected from the first image data group; and performing control of displaying, in a third region of the display, a second image data group including second image data selected from the plurality of image data based on a second criterion based on specific image data that is at least one of the selected image data.

Still another aspect of the present invention relates to a display control method comprising: acquiring a plurality of image data; performing control of displaying, in a first region of a display, a first image data group including representative image data of each group obtained by grouping the plurality of acquired image data; performing control of displaying, in a second region of the display, selected image data that is at least one image data selected from the first image data group; and performing control of displaying, in a third region of the display, a second image data group that is image data of the group including specific image data that is at least one image data of the selected image data.

Still another aspect of the present invention relates to a display control program, which is stored in a computer readable medium, causing a processor to execute steps comprising: acquiring a plurality of image data; performing control of displaying, in a first region of a display, a first image data group including a plurality of first image data selected from the plurality of acquired image data based on a first criterion; performing control of displaying, in a second region of the display, selected image data that is at least one image data selected from the first image data group; and performing control of displaying, in a third region of the display, a second image data group including second image data selected from the plurality of image data based on a second criterion based on specific image data that is at least one of the selected image data.

Still another aspect of the present invention relates to a display control program, which is stored in a computer readable medium, causing a processor to execute steps comprising:

acquiring a plurality of image data; performing control of displaying, in a first region of a display, a first image data group including representative image data of each group obtained by grouping the plurality of acquired image data; performing control of displaying, in a second region of the display, selected image data that is at least one image data selected from the first image data group; and performing control of displaying, in a third region of the display, a second image data group that is image data of the group including specific image data that is at least one image data of the selected image data.

According to the present invention, it is possible to support the work of selecting the desired image from the plurality of images.

### BRIEF DESCRIPTION OF THE DRAWINGS

FIG. 1 is a diagram showing a schematic configuration of an image management system 100 including a display control apparatus 40 that is an embodiment of a display control apparatus of the present invention.

FIG. 2 is a schematic diagram for describing a first selection process executed by a processor 43.

FIG. 3 is a schematic diagram of an example in which an image data group 50A shown in FIG. 2 is grouped.

FIG. 4 is a diagram schematically showing a display region 44R of a display 44.

FIG. 5 is a diagram schematically showing a modification example of display contents of the display 44.

FIG. 6 is a diagram schematically showing a modification example of the display contents of the display 44.

FIG. 7 shows an example in which image data displayed on the leftmost side out of image data of a group G1 displayed in a third region 44C is selected in the state shown in FIG. 4.

FIG. 8 is a diagram showing a display example in which a favorite operation is performed on image data 51 of the group G1 displayed in a second region 44B in the state shown in FIG. 7.

### DESCRIPTION OF THE PREFERRED EMBODIMENTS

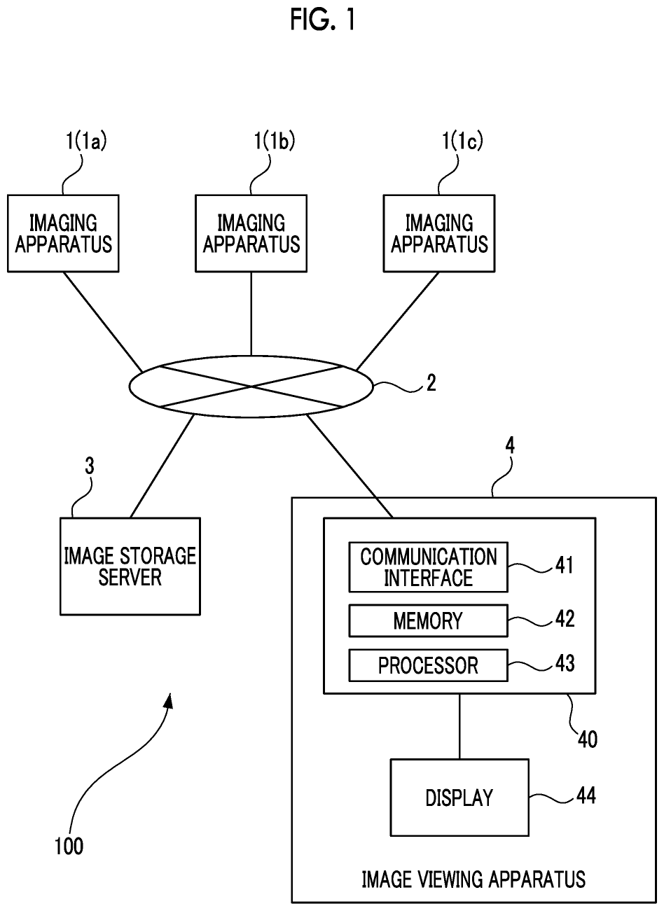

FIG. 1 is a diagram showing a schematic configuration of an image management system 100. The image management system 100 includes a display control apparatus 40 that is an embodiment of a display control apparatus of the present invention. The image management system 100 comprises an imaging apparatus 1, a network 2, such as the Internet or a local area network (LAN), an image storage server 3, and an image viewing apparatus 4.

In the example of FIG. 1, a plurality of imaging apparatuses 1 are displayed, but the number of imaging apparatuses 1 may be one. The plurality of imaging apparatuses 1 include three imaging apparatuses: an imaging apparatus (first imaging apparatus) 1a, an imaging apparatus (second imaging apparatus) 1b, and an imaging apparatus (third imaging apparatus) 1c.

The imaging apparatus 1 and the image viewing apparatus 4 are disposed in, for example, an event site, such as a wedding hall, or an imaging studio. Three imaging apparatuses 1 are disposed at different positions in one installation place, and are configured to image an imaging target subject, such as a person or an animal, existing in the installation place from different directions. The image captured by each imaging apparatus 1 may include the imaging target subject, may include another subject (a person or an animal existing in the installation place) other than the imaging target subject in addition to the imaging target subject, or may include only another subject. In a case where the installation place is a wedding hall, the imaging target subject is, for example, a bride and groom. In this case, the other subject is, for example, a participant who is a person other than the bride and groom.

The imaging apparatus 1 includes an imaging element, an image processing circuit, and a communication interface connectable to a network 2. The image processing circuit processes a captured image signal to generate image data. The captured image signal is obtained by imaging the subject via the imaging element. The imaging apparatus 1 is configured with, for example, a digital camera or a smartphone. The image data generated by the imaging apparatus 1 is also referred to as image data captured by the imaging apparatus 1. A tag of the image data generated by the imaging apparatus 1 includes a generation time point of the image data (synonymous with an imaging time point) and identification information of the imaging apparatus 1 that generates the image data. The imaging apparatus 1 transmits the generated image data to the image storage server 3 through the network 2. The imaging apparatus 1 executes imaging automatically and continuously or at predetermined intervals under the control of a control apparatus (not shown). Therefore, a large amount of image data is sequentially uploaded to the image storage server 3.

The image storage server 3 comprises a processor, a communication interface connectable to the network 2, and a storage device, such as a solid state drive (SSD) or a hard disk drive (HDD). The storage device may be a network storage device connected to the network 2. The processor of the image storage server 3 acquires the image data transmitted from the imaging apparatus 1, and stores the acquired image data in the storage device.

The image viewing apparatus 4 is an apparatus for enabling viewing of a part or all of the images based on all of the image data stored in the storage device of the image storage server 3. In other words, the image viewing apparatus 4 acquires a large number of image data captured by the imaging apparatus 1, and enables viewing of the images. The image viewing apparatus 4 comprises a display 44 and a display control apparatus 40. The display 44 is a liquid crystal display panel, an organic electro-luminescence (EL) display panel, or the like. The display control apparatus 40 performs displaying, on the display 44, the image based on the image data. The display 44 has a touch panel, and a user can perform various operations on a display region with a finger or the like. The display 44 does not have to include a touch panel. In this case, the display 44 need only be operated by using an operation device, such as a mouse, connected to the display control apparatus 40.

The display control apparatus 40 comprises a communication interface 41 for connecting to the network 2, a memory 42 including a random access memory (RAM) and a read only memory (ROM), and a processor 43.

Each of the processor of the image storage server 3 and the processor 43 of the display control apparatus 40 is a central processing unit (CPU), a programmable logic device (PLD), a dedicated electric circuit, or the like. The CPU is a general-purpose processor that performs various functions by executing software (program). The PLD is a processor whose circuit configuration can be changed after manufacturing, and includes, for example, a field programmable gate array (FPGA). The dedicated electric circuit is a processor having a circuit configuration designed exclusively for executing a specific process, and includes, for example, an application specific integrated circuit (ASIC). Each of the processor of the image storage server 3 and the processor 43 of the display control apparatus 40 may be configured with one processor, or may be configured with a combination of two or more processors of the same type or different types (for example, a combination of a plurality of FPGAs or a combination of a CPU and an FPGA). Specifically, a hardware structure of the processor of the image storage server 3 and the processor 43 of the display control apparatus 40 is an electric circuit (circuitry) in which circuit elements, such as semiconductor elements, are combined.

Next, a process performed by the processor 43 of the display control apparatus 40 will be described. The process performed by the processor 43 roughly includes an image selection process and a display process. The image selection process includes a first selection process, a grouping process, and a second selection process.

### Image Selection Process

The processor 43 acquires unacquired image data out of the image data stored in the storage device of the image storage server 3 at a specific timing through the network 2. The processor 43 selects image data satisfying a predetermined condition from the acquired image data, and generates various image data groups. Here, the specific timing is, for example, each time a predetermined time elapses or a timing at which the number of image data newly stored in the storage device of the image storage server 3 reaches a predetermined value. Hereinafter, all of the image data acquired from the image storage server 3 is referred to as an acquired image data group 50.

### First Selection Process

The processor 43 executes the first selection process of selecting the image data from the acquired image data group 50 based on a first criterion to obtain an image data group 50A including a plurality of selected image data. That is, the first selection process is a process of selecting the image data from the acquired image data group 50 based on the first criterion to generate a new image data group 50A.

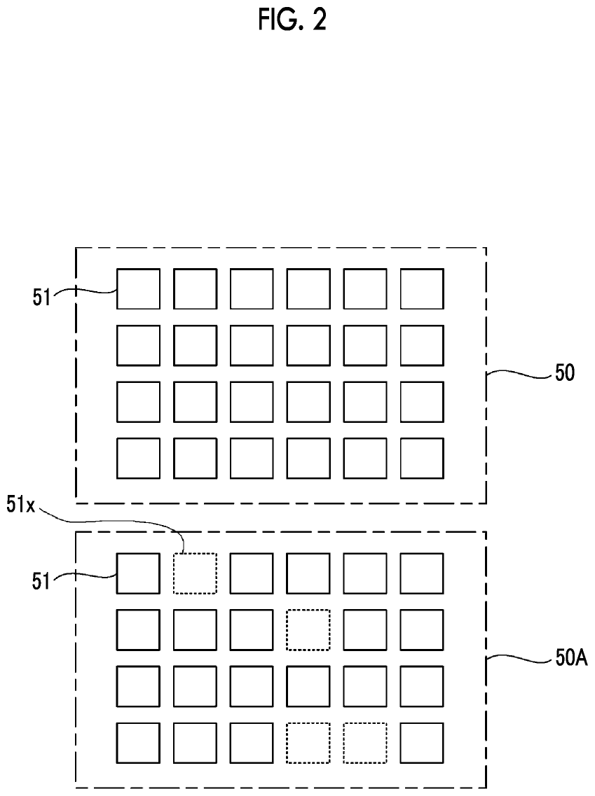

FIG. 2 is a schematic diagram for describing the first selection process executed by the processor 43. An upper diagram of FIG. 2 shows the acquired image data group 50, and a lower diagram shows the image data group 50A obtained by the first selection process. As described above, the acquired image data group 50 includes all of the image data acquired by the processor 43 from the image storage server 3. A rectangle included in the acquired image data group 50 indicates image data 51 included in the acquired image data group 50. In the first selection process, the processor 43 selects the image data 51 satisfying the first criterion from the acquired image data group 50 shown in the upper diagram of FIG. 2 to obtain the image data group 50A including the selected image data 51 (see the lower diagram of FIG. 2). In the image data group 50A, a broken-line rectangle (image data 51x) indicates image data that does not satisfy the first criterion and is not selected by the processor 43. That is, a relationship between the total number N of image data included in the acquired image data group 50 and the number M of plurality of image data selected based on the first criterion is N≥M. The image data included in the acquired image data group 50 are all the image data acquired by the processor 43.

The first criterion is a criterion relating to an image quality of the image data. Specifically, the first criterion is a criterion that the image quality is equal to or higher than a predetermined threshold value (score threshold value). In other words, the first criterion is a criterion for determining whether or not the image quality is equal to or higher than the score threshold value. In a case where the image quality is equal to or higher than the score threshold value, the processor 43 determines that the image data having the image quality satisfies the first criterion, and selects the image data from the acquired image data group 50.

The first criterion is not limited to the criterion relating to the image quality. The first criterion may be a criterion for determining whether or not a person or an animal is included in the image data. Alternatively, the first criterion may be a criterion for determining whether or not the image data is selected by the user of the image viewing apparatus 4.

The determination of whether or not the image quality is equal to or higher than the score threshold value is performed by, for example, performing image quality evaluation of the image data to derive a score. Specifically, in a case where the score derived for the image data is equal to or higher than the predetermined score threshold value, the processor 43 determines that the image data satisfies the first criterion.

The score of the image data can be derived based on an evaluation value of any item. Specifically, any item is not limited to the image quality, and includes an attribute of a color, a sharpness of the subject, a facial expression of the subject, a position or a size of the subject, a direction of the subject, and the like. More specifically, examples of the evaluation value of the attribute of the color include values of brightness, color, and contrast. Examples of the evaluation value of the sharpness of the subject include an evaluation value of a sharpness of the person or the animal included in the image data. The evaluation value of the facial expression of the subject is determined, for example, depending on whether or not the eyes of the person or the animal included in the image data are open. The evaluation value of the position or the size of the subject is determined depending on whether or not the position or the size of the person or the animal included in the image data satisfies a predetermined condition. Further, the evaluation value of the direction of the subject is determined depending on whether or not the direction of the face of the person or the animal included in the image data satisfies a predetermined condition. For example, a value obtained by adding a plurality of evaluation values may be used as the score. Alternatively, one of the plurality of evaluation values may be used as the score as it is.

### Grouping Process

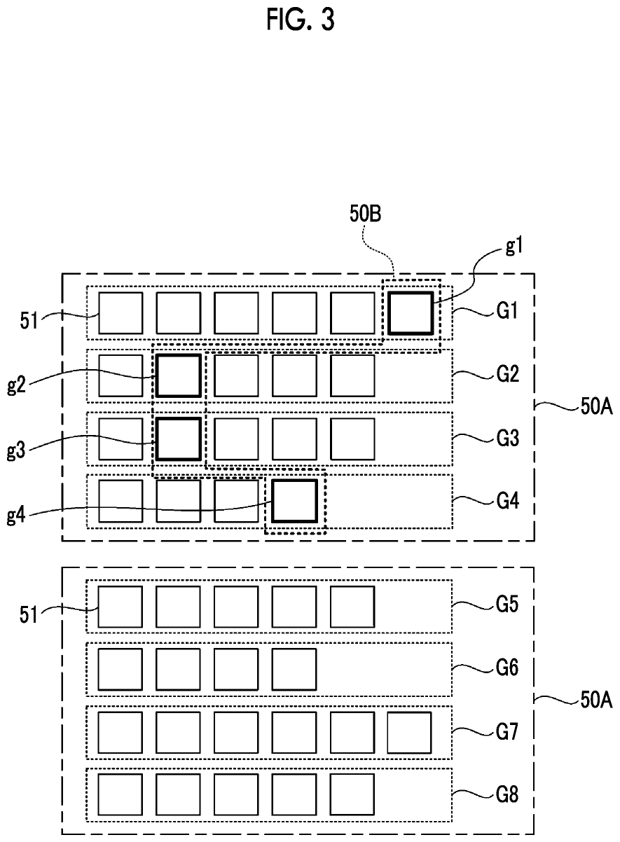

The processor 43 further executes the grouping process of grouping the plurality of image data 51, which are included in the image data group 50A obtained by the first selection process. FIG. 3 is a schematic diagram showing an example in which the image data group 50A is grouped. The grouping process is performed based on the features of the image data 51. Here, the features of the image data 51 include similarity of the composition and similarity of the subject.

Specifically, the processor 43 generates a plurality of groups G1 to G4 from the image data group 50A by executing the grouping process. For example, the processor 43 groups the image data 51 having compositions close to each other out of the image data 51 included in the image data group 50A to generate a group G1, a group G2, a group G3, and a group G4 shown in FIG. 3. The group G1 is a group consisting of only image data of a first composition and a composition close to the first composition. The group G2 is a group consisting of only image data of a second composition and a composition close to the second composition. The group G3 is a group consisting of only image data of a third composition and a composition close to the third composition. The group G4 is a group consisting of only image data of a fourth composition and a composition close to the fourth composition.

For example, in a case of classifying the image data 51 included in the image data group 50A based on the similarity of the subject, the processor 43 may perform the grouping based on whether or not the image data 51 includes a common person or animal. For example, as shown in FIG. 3, the processor 43 generates a group G5, a group G6, a group G7, and a group G8 based on the image data group 50A. The group G5 generates a group consisting of only image data including a first person. The group G6 generates a group consisting of only image data including a second person. The group G7 generates a group consisting of only image data including a third person. The group G8 generates a group consisting of only the image data including a fourth person.

The processor 43 may execute both the grouping process of generating the group G1, the group G2, the group G3, and the group G4 and the grouping process of generating the group G5, the group G6, the group G7, and the group G8. That is, the processor 43 may perform only the grouping process based on any one of the similarity of the composition or the similarity of the subject, or may perform the grouping process based on both the similarity of the composition and the similarity of the subject. Alternatively, the image data group 50A may be grouped by other methods. Hereinafter, a case where the processor 43 executes only the grouping process of generating the group G1, the group G2, the group G3, and the group G4 will be described as a basic case.

The processor 43 further selects representative image data as a representative of the group from each of the group G1, the group G2, the group G3, and the group G4 obtained by the grouping process. The processor 43 obtains a representative image data group 50B (corresponding to a first image data group) including a plurality of selected representative image data. The representative image data is selected based on any selection criterion. For example, any item relating to the evaluation value described above may be used as any selection criterion. For example, the value of the score and the size of the subject may be used as any selection criterion. Specifically, the representative image data is, for example, the image data having the maximum score or the image data in which the size of the included person or animal is the maximum out of the image data belonging to the group.

In the example of FIG. 3, the image data 51 at the right end in the group G1 is selected as representative image data g1 of the group G1. The second image data 51 from the left in the group G2 is selected as representative image data g2 of the group G2. The second image data 51 from the left in the group G3 is selected as representative image data g3 of the group G3. The image data 51 at the right end in the group G4 is selected as representative image data g4 of the group G4.

The first selection process may be omitted, and the grouping process may be replaced with a process of grouping the image data of the acquired image data group 50. That is, in the first selection process described above, the image data group 50A is generated by using the first criterion, but the image data group 50A may be generated in the grouping process.

### Second Selection Process

The processor 43 further executes the second selection process of selecting the image data from the image data group 50A obtained by the first selection process based on a second criterion to obtain an image data group 50C (corresponding to a second image data group) including the selected image data. In other words, the second selection process is a process of selecting the image data from the image data group 50A based on the second criterion to generate a new image data group 50C.

Hereinafter, one or a plurality of image data selected from the representative image data group 50B by an operation from the user are also referred to as selected image data. The one selected image data or one selected image data further selected by the user from the plurality of selected image data is also referred to as specific image data. The second criterion is a criterion based on the specific image data.

For example, the second criterion is a criterion relating to a degree of similarity with the specific image data. Specifically, the second criterion is a criterion (hereinafter, referred to as a second criterion S2a) that a degree of similarity of the composition or a degree of similarity of the image quality (brightness, contrast, or the like) is equal to or higher than a similarity threshold value as compared with the specific image data.

In a case where the degree of similarity is related to the composition, the processor 43 selects the image data having a composition close to the composition of the specific image data from the image data group 50A to generate the image data group 50C. For example, in a case where the representative image data g4 is the specific image data of the image data group 50A shown in FIG. 3, three image data 51 other than the representative image data g4 of the group G4 are selected as the image data group 50C.

In the second selection process, the image data is selected from the image data group 50A based on the second criterion. On the other hand, the second selection process may be a process of selecting the image data from the acquired image data group 50 instead of the image data group 50A based on the second criterion. That is, the image data group 50C may include the image data selected from the acquired image data group 50 based on the second criterion. In this case, even an image data that does not satisfy the first criterion can be included in the image data group 50C as long as the degree of similarity with the specific image data is high.

A plurality of second criteria may be set, and the plurality of second criteria may be switchable by an operation from the user. That is, a plurality of types of second criteria may be provided, and the types of the second criteria may be switched at any timing. For example, the second criterion may be set based on the degree of similarity (sameness) of the subject in addition to the degree of similarity of the composition or the degree of similarity of the image quality described above. The degree of similarity (sameness) of the subject means the similarity between the person or animal included in the image data and the person or animal included in the specific image data. In other words, a criterion (hereinafter, referred to as a second criterion S2b) that the image data includes the same person or animal as the person or animal included in the specific image data may be further selectable as the second criterion. In this case, the processor 43 selects the image data including the same person or animal as the person or animal included in the specific image data from the image data group 50A (or the acquired image data group 50), and sets the selected image data as the image data group 50C. As shown in FIG. 3, the group G5, the group G6, the group G7, and the group G8 are generated in addition to the group G1, the group G2, the group G3, and the group G4. In a case where the specific image data belongs to the group G6, the processor 43 selects the image data 51 excluding the specific image data from the image data belonging to the group G6, and sets the selected image data as the image data group 50C.

Alternatively, a criterion (hereinafter, referred to as a second criterion S2c) that the image data is image data captured in a predetermined period by the imaging apparatus 1 different from the imaging apparatus 1 that captures the specific image data may be further selectable as the second criterion. The predetermined period is a period based on an imaging time point of the specific image data. The predetermined period is, for example, several seconds before and after the imaging time point of the specific image data by the imaging apparatus 1, several seconds immediately before the imaging time point of the specific image data by the imaging apparatus 1, or several seconds immediately after the imaging time point of the specific image by the imaging apparatus. In a case where the imaging apparatus 1 that captures the specific image data is, for example, the second imaging apparatus 1b, the processor 43 selects the image data captured in the predetermined period by the first imaging apparatus 1a and the image data captured in the predetermined period by the third imaging apparatus 1c from the image data group 50A (or the acquired image data group 50) to generate the image data group 50C. In a case where the imaging apparatus 1 that captures the specific image data is the first imaging apparatus 1a, the processor 43 selects the image data captured in the predetermined period by the second imaging apparatus 1b and the third imaging apparatus 1c from the image data group 50A (or the acquired image data group 50) to generate the image data group 50C.

Alternatively, another second criterion in which the imaging time point of the second criterion S2c is not taken into consideration may be set. Specifically, a criterion (hereinafter, referred to as a second criterion S2d) that the image data is image data captured by the imaging apparatus 1 different from the imaging apparatus 1 that captures the specific image data may be further selectable as the second criterion. In this case, in a case where the imaging apparatus 1 that captures the specific image data is, for example, the third imaging apparatus 1c, the processor 43 selects the image data captured by the first imaging apparatus 1a and the image data captured by the second imaging apparatus 1b from the image data group 50A (or the acquired image data group 50) to generate the image data group 50C. In a case where the imaging apparatus that captures the specific image data is the first imaging apparatus 1a, the processor 43 selects the image data captured by the second imaging apparatus 1b and the third imaging apparatus 1c from the image data group 50A (or the acquired image data group 50) to generate the image data group 50C.

As described above, as the second criterion, any one of the plurality of criteria (the second criterion S2a, the second criterion S2b, the second criterion S2c, and the second criterion S2d) may be set, or two or more of the plurality of criteria may be set and one of the two or more second criteria may be selectable.

### Display Process

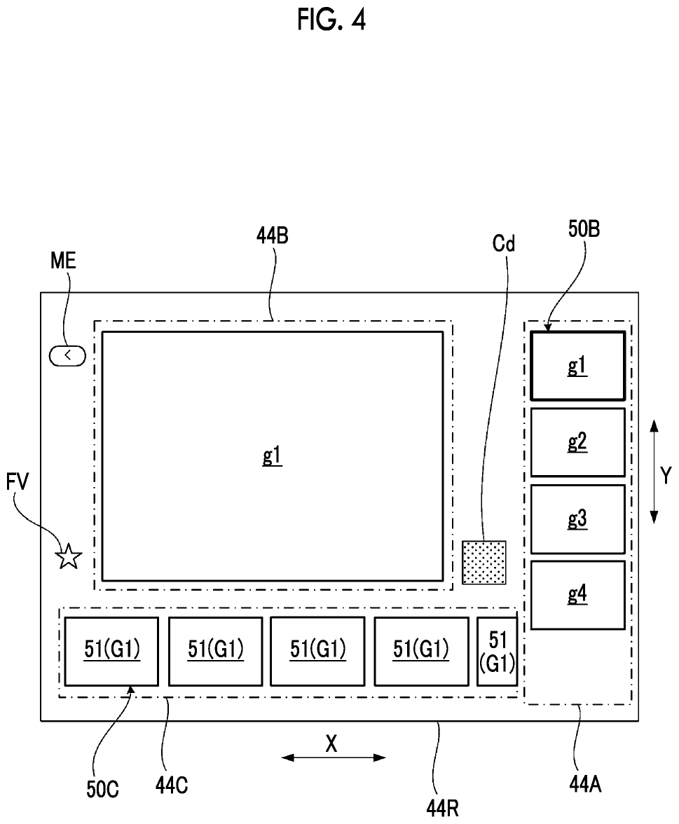

FIG. 4 is a diagram schematically showing a display region 44R of the display 44. The display region 44R has a rectangular shape, a direction X (corresponding to a second direction) is a longitudinal direction, and a direction Y (corresponding to a first direction) intersecting (in the example of FIG. 4, orthogonal to) the direction X is a lateral direction. A first region 44A, a third region 44C, and a second region 44B are set in the display region 44R.

The first region 44A extends along the direction Y. The first region 44A is disposed on one end side in the direction X. The first region 44A is a rectangle having long sides along the direction Y. In the first region 44A, the plurality of representative image data included in the representative image data group 50B are displayed in a form arranged along the direction Y.

The third region 44C extends along the direction X. The third region 44C is disposed on one end side in the direction Y. The third region 44C is a rectangle having long sides along the direction X. In the third region 44C, the plurality of image data included in the image data group 50C are displayed in a form arranged along the direction X.

The second region 44B is disposed adjacent to the first region 44A in the direction X and adjacent to the third region 44C in the direction Y. In the second region 44B, the image data can be displayed in a larger size than the image data displayed in the first region 44A and the third region 44C. The image selected by the user is selected in the second region 44B. Specifically, any one of the image data selected in the first region 44A or the image data selected in the third region 44C is displayed. In the display region 44R, a menu icon ME operable by the user, a favorite icon FV operable by the user, and a two dimensional code Cd are further displayed.

### Display of Representative Image Data Group 50B

The processor 43 performs control of displaying, in the first region 44A, the image based on the representative image data group 50B in a form arranged in the direction Y. In the example of FIG. 3, the representative image data group 50B includes the representative image data g1, the representative image data g2, the representative image data g3, and the representative image data g4. In other words, in the first region 44A, the images based on the plurality of representative image data g1 to g4 are displayed in a form arranged in the direction Y.

Although the image based on the image data is mainly displayed on the display 44 or selected or operated by the user or the like in this way, in the present specification, the expression “image data” may be used instead of the expression “image based on image data” for convenience of description. That is, “displaying the image data”, “selecting the image data”, “operating the image data”, and the like may be described. Accordingly, “displaying the image data” means “displaying the image based on the image data”. “Selecting the image data” means “selecting the image based on the image data”. “Operating the image data” means “operating the image based on the image data”. The display, the selection, the operation, and the like of the image data may include the display, the selection, the operation, and the like of tag information and the like added to the image.

In the example of FIG. 4, the representative image data is displayed in a form arranged in a row in the first region 44A, but the first region 44A may have a configuration in which the representative image data of a plurality of rows can be displayed. Accordingly, in a case where the number of representative image data included in the representative image data group 50B is large, the representative image data can be displayed in a form arranged in a plurality of rows in the first region 44A. The first region 44A may have a configuration in which scroll display can be performed. Accordingly, in a case where the number of representative image data included in the representative image data group 50B is large and cannot be displayed in the first region 44A at once, all of the representative image data need only be displayed by the scroll display.

### Display of Selected Image Data

The processor 43 performs control of displaying the selected image data in the second region 44B. As described above, the selected image data is one or a plurality of representative image data selected by an operation from the user from the representative image data group 50B displayed in the first region 44A.

In the example of FIG. 4, the user selects the representative image data g1 of the representative image data group 50B displayed in the first region 44A, and the representative image data g1 is displayed in the second region 44B as the selected image data. In a case where the user does not select the representative image data, the representative image data based on a predetermined rule may be displayed in the second region 44B. For example, the processor 43 may select the representative image data g1 displayed at the uppermost portion of the first region 44A in the representative image data group 50B to display the representative image data g1 in the second region 44B.

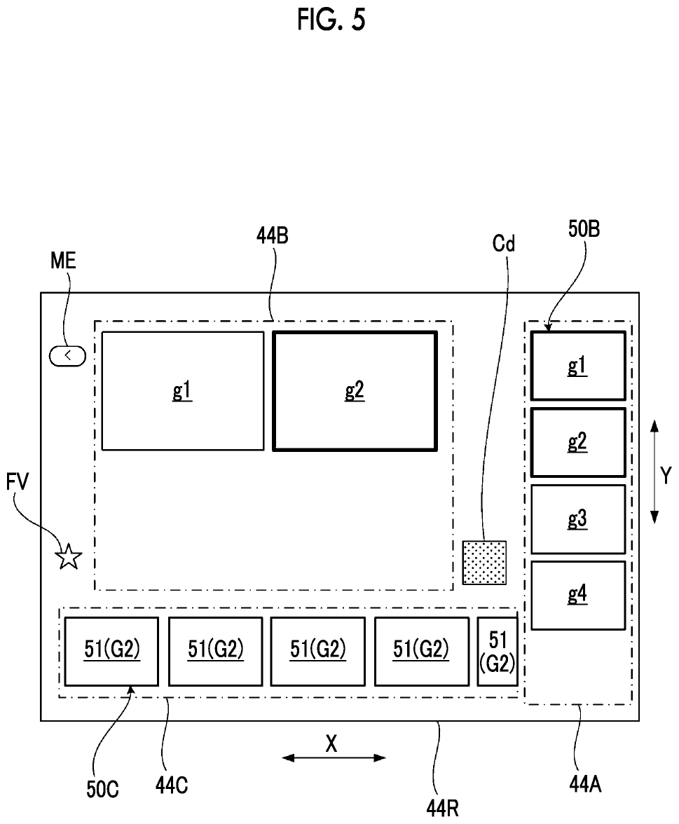

FIG. 5 is a diagram schematically showing a modification example of display contents of the display 44. FIG. 5 shows a display example in a case where the plurality of (here, two) representative images in the representative image data group 50B displayed in the first region 44A are selected by the user. In a case where the plurality of representative image data are selected from the representative image data displayed in the first region 44A, the processor 43 performs control of displaying the plurality of representative image data in the second region 44B. In the example of FIG. 5, the representative image data g1 and the representative image data g2 are selected from the representative image data group 50B, and the representative image data g1 and the representative image data g2 are displayed in the second region 44B as the selected image data.

### Display of Image Data Group 50C

The processor 43 performs control of selecting the image data from the image data group 50A (or the acquired image data group 50) based on the second criterion to display the image data group 50C including the selected image data in the third region 44C. The second criterion is a criterion based on the specific image data which is any one of the selected image data displayed in the second region 44B.

FIG. 4 shows a case where the number of image data that can be displayed in the second region 44B is one. In this case, the second criterion S2a is used as the second criterion. In FIG. 4, the representative image data g1 is selected in the first region 44A, and the representative image data g1 as the selected image data is displayed in the second region 44B. Since there is one selected image data, the representative image data g1 is the specific image data. The representative image data g1 is included in the group G1 (see FIG. 3). Therefore, the processor 43 generates the image data group 50C consisting of the image data 51 excluding the representative image data (specific image data) g1 out of the image data of the group G1. Further, the processor 43 further performs control of displaying, in the third region 44C, the image data 51 included in the image data group 50C in a form arranged in the direction X.

In the example of FIG. 4, the image data 51 is displayed in a form arranged in a row in the third region 44C, but the third region 44C may have a configuration in which a plurality of rows of the image data can be displayed in a form arranged along the direction Y. Accordingly, in a case where the number of image data included in the image data group 50C is large, the image data 51 can be displayed in a form arranged in a plurality of rows in the third region 44C. The third region 44C may have a configuration in which scroll display can be performed. Accordingly, in a case where the number of image data 51 belonging to the image data group 50C is large and all of the image data 51 cannot be displayed at once in the third region 44C, all of the image data 51 need only be displayed by scroll display.

FIG. 5 shows a case where the number of image data that can be displayed in the second region 44B is plural. Even in this case, the second criterion S2a is used as the second criterion. Two representative image data g1 and g2 are selected in the first region 44A, and the two representative image data g1 and g2 as the selected image data are displayed in the second region 44B. The representative image data g2 is selected from the two representative image data g1 and g2 in the second region 44B. Accordingly, the representative image data g2 is the specific image data.

The representative image data g2, which is the specific image data, is included in the group G2 (see FIG. 3). Therefore, the processor 43 generates the image data group 50C consisting of the image data excluding the specific image data (representative image data g2) out of the image data of the group G2. The processor 43 performs control of displaying, in the third region 44C, the image data included in the image data group 50C in a form arranged in the direction X. In other words, in the example of FIG. 5, the representative image data g2 selected by the user in the second region 44B is the specific image data, and the image data excluding the representative image data g2 out of the image data 51 belonging to the group G2 including the representative image data g2 is displayed in the third region 44C.

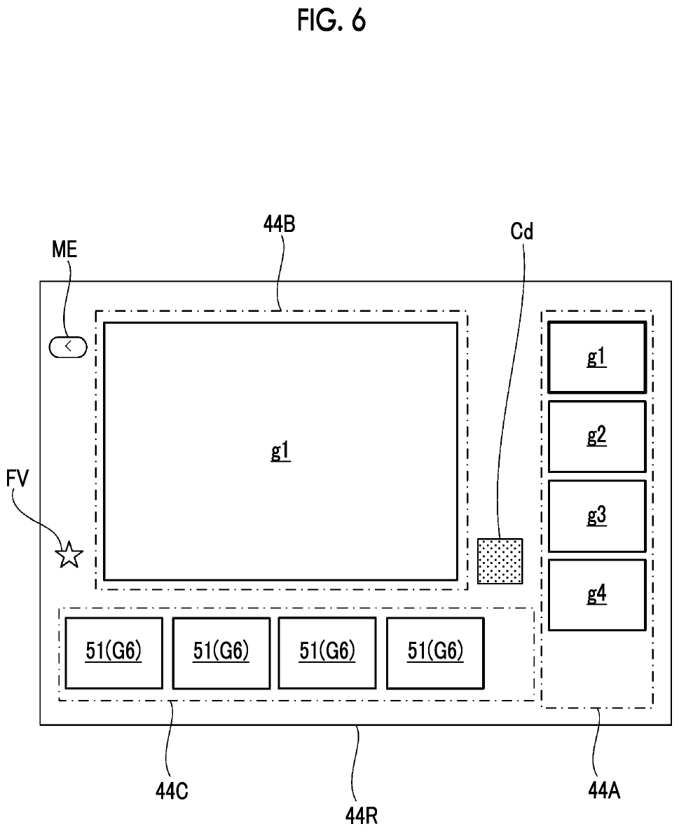

FIG. 6 shows a case where the number of image data that can be displayed in the second region 44B is one. Here, the second criterion S2b is used as the second criterion. The representative image data g1 is selected in the first region 44A, and the representative image data g1 as the selected image data is displayed in the second region 44B. Since there is one selected image data, the representative image data g1 is the specific image data. Here, it is assumed that the group including the representative image data g1 is the group G6. Therefore, the processor 43 generates the image data group 50C consisting of the image data 51 excluding the representative image data g1 out of the image data included in the group G6. The processor 43 performs control of displaying, in the third region 44C, the image data included in the image data group 50C in a form arranged in the direction X.

In a case where another criterion is selected as the second criterion by the operation of the menu icon ME or the like, the processor 43 changes the image data group 50C being displayed in the third region 44C to the image data group 50C obtained based on the other criterion.

In a case where one or a plurality of image data are selected by an operation from the user from the image data group 50C being displayed in the third region 44C, the processor 43 performs control of displaying the selected image data in the second region 44B.

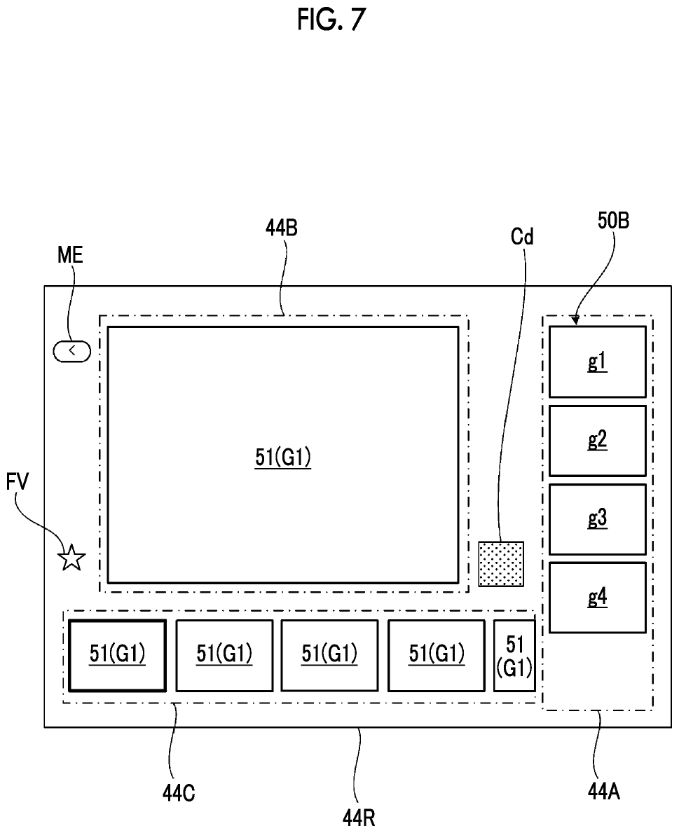

FIG. 7 shows an example in which image data displayed on the leftmost side out of the image data of the group G1 displayed in the third region 44C is selected in the state where the representative image data g1 is selected in the first region 44A (see FIG. 4). In the example of FIG. 7, the image displayed in the second region 44B is changed from the representative image data g1 to the image data 51 being selected from the image data group 50C. That is, in a case where the image data 51 is selected in the third region 44C in a state where the representative image data g1 is displayed in the second region 44B, the processor 43 changes the image displayed in the second region 44B from the representative image data g1 to the image data 51.

### Display of Acquisition Image

The processor 43 performs control of displaying an acquisition image for acquiring the image data in the display region 44R. The acquisition image is an image used to acquire the image data displayed in the second region 44B from the image storage server 3. The acquisition image is, for example, the two dimensional code Cd.

In the example of FIG. 4, the processor 43 displays the two dimensional code Cd in the vicinity of the second region 44B. The two dimensional code Cd is obtained by encoding a uniform resource locator (URL) for accessing a storage place of the representative image data g1.

Even in the example of FIG. 5, the processor 43 displays the two dimensional code Cd in the vicinity of the second region 44B. In the example of FIG. 5, the two dimensional code Cd is obtained by encoding a URL for accessing a storage place of the representative image data g2.

Even in the example of FIG. 7, the processor 43 displays the two dimensional code Cd in the vicinity of the second region 44B. Here, the two dimensional code Cd is obtained by encoding a URL for accessing a storage place of the image data 51 selected from the image data group 50C.

By using the acquisition image, the user can easily acquire the selected image data via a smartphone or the like owned by the user.

### Favorite Process

The processor 43 executes a favorite process on any image data. The favorite process is a process of adding favorite information to any image data. Here, the favorite information is information indicating the image data on which a favorite operation is performed. The favorite operation means an operation of the favorite icon FV by the user. Any image data is image data designated by the user among one or a plurality of image data displayed in the second region 44B. In other words, any image data is the representative image data selected from the representative image data group 50B or the image data selected from the image data group 50C and designated by the user.

The favorite process is performed based on the favorite operation by the user. In a case where the user performs the favorite operation, the processor 43 detects a favorite addition instruction (request for addition of information). In a case where the processor 43 detects the request for addition of the information for any one of the image data displayed in the second region 44B, the processor 43 adds the favorite information to, for example, the tag of the image data.

It is preferable that, in a case where the image data to which the favorite information is added is displayed in the display region 44R, the processor 43 performs control of displaying the image data in a mode distinguishable from the image data to which the favorite information is not added. For example, the processor 43 superimposes and displays a star mark equivalent to the favorite icon FV on the image data to which the favorite information is added.

The image selection process described above is performed each time the acquired image data group 50 is updated. In other words, the image selection process is performed in a case where the processor 43 acquires new image data from the image storage server 3. For this reason, at least one of the representative image data group 50B or the image data group 50C can be updated in a case where the processor 43 acquires the new image data from the image storage server 3. Therefore, it is preferable that, in a case where the new image data is included in the representative image data group 50B or the image data group 50C, the processor 43 performs control of displaying the new image data in a mode in which the new image data can be distinguished from other image data. The distinguishable mode is, for example, adding an icon to the new image data or changing a color of an outer frame of the new image data. Accordingly, the user can easily recognize the new image data, and the efficiency of the work of selecting the image data can be enhanced.

### Main Effect of Image Viewing Apparatus 4

With the image viewing apparatus 4, the representative image data group 50B obtained by grouping a large amount of image data is displayed in the first region 44A.

In a case where the second criterion S2a or the second criterion S2b is adopted, the user can check the selected representative image data in the second region 44B in a large display size only by performing the operation of selecting the representative image data of interest from the representative image data group 50B. Further, the user can check, in the third region 44C, the image data group 50C consisting of the image data similar to the representative image data (selected image data) selected in the second region 44B. Accordingly, it is easy to compare the image data of interest with the image data similar to the image data of interest, and it is possible to easily select desired image data from the image data group 50A or the acquired image data group 50.

In a case where the second criterion S2c or the second criterion S2d is adopted, the user can check, in the third region 44C, image data of a predetermined subject captured at a plurality of viewpoints. In other words, it is possible to check, in the third region 44C, the image data group 50C obtained by imaging the subject at a different viewpoint from the imaging apparatus 1 that captures the selected image data. That is, the user can check, in one display region 44R, the image data of interest and the image data that is related to the image data of interest and captured by another surrounding imaging apparatus 1. For example, the plurality of image data obtained by imaging the same subject from different angles can be checked. Accordingly, the selection of the image data by the user can be supported.

As shown in FIGS. 4 and 5, a display size of the image data displayed in the second region 44B is larger than a display size of each image data displayed in the first region 44A. Thus, the user can check in detail the representative image data selected from the representative image data group 50B of a small display size displayed in the first region 44A, in a large display size in the second region 44B. The display size of the image data displayed in the second region 44B is larger than a display size of each image data displayed in the third region 44C. Thus, the user can check in detail the image data selected from the image data group 50C of a small display size displayed in the third region 44C, in a large display size in the second region 44B.

The display size of each image data displayed in the first region 44A may be the same as or different from the display size of each image data displayed in the third region 44C. In a case where the second criterion S2a is adopted, the display size or the display mode of each image data of the image data group 50C displayed in the third region 44C may be varied according to the degree of similarity with the specific image data. For example, the image data of the image data group 50C may be displayed in a larger display size as the degree of similarity with the specific image data is higher. Alternatively, as the degree of similarity with the specific image data is higher, a thickness of a frame of the image data of the image data group 50C may be displayed to be greater. Thus, the user can easily discriminate an image having a high degree of similarity with the specific image data.

A direction in which one side of the representative image data displayed in the second region 44B extends matches the direction X in which the image data of the image data group 50C are arranged. Most of the image data of the representative image data group 50B displayed in the first region 44A have low relevance to the image data displayed in the second region 44B. In contrast, in the case where the second criterion S2a is adopted, each image data of the image data group 50C displayed in the third region 44C has high relevance to the image data displayed in the second region 44B. As described above, since the image data group 50C having high relevance is displayed in a form arranged in the longitudinal direction of the display region 44R, it is possible to enhance the visibility of the image having high relevance.

### Preferable Process

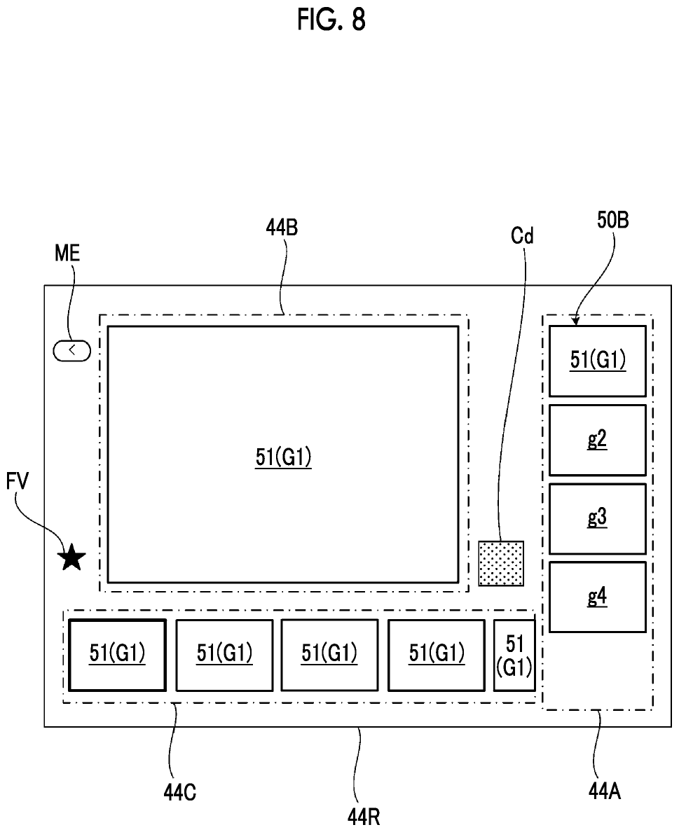

FIG. 8 shows an example in which the favorite operation is performed in a state where the leftmost image data out of the plurality of image data displayed in the third region 44C is selected (see FIG. 7). In other words, FIG. 8 shows a display example of the display 44 in a case where the favorite operation is performed on the image data 51 (G1) displayed in the second region 44B. The image data 51 (G1) indicates the image data 51 belonging to the group G1.

In this example, it is assumed that the image data 51 (G1) displayed in the second region 44B does not match each image data included in the representative image data group 50B. That is, it is assumed that the image data 51 (G1) included in the representative image data group 50B and the image data 51 (G1) selected in the image data group 50C belong to the same group G1 but are different from each other.

In a case where the representative image data and the image data to which the favorite information is added do not match out of the image data belonging to the same group, the processor 43 may perform a process of replacing the representative image data of the group with the image data to which the favorite information is added in the group. In the example of FIG. 8, the favorite information is not added to the representative image data g1, and the favorite information is added to the image data 51 displayed in the second region 44B. Therefore, in this case, the representative image data g1 displayed in the first region 44A is changed to the image data 51 displayed in the second region 44B. In other words, the image data 51 which is selected in the third region 44C and to which the favorite information is added is replaced with the representative image data g1. As a result, it is possible to change another image data selected by the user from the group including the representative image data determined by the processor 43 to the representative image data of the group, and it is possible to perform display in which the intention of the user is reflected.

The replacement of the representative image data g1 may be performed by the processor 43 at a timing at which the favorite information is added to the image data 51 displayed in the second region 44B. Alternatively, the replacement of the representative image data g1 may be performed by the processor 43 at a timing at which the image data is reloaded into the image viewing apparatus 4.

The favorite operation may be performed on each image data displayed in the first region 44A and each image data displayed in the third region 44C in addition to the image data displayed in the second region 44B. Alternatively, the favorite operation may be performed on at least one of each image data of the first region 44A or each image data of the third region 44C in addition to the image data of the second region 44B.

For example, the favorite icon FV is superimposed and displayed on each image data displayed in the first region 44A and each image data displayed in the third region 44C. Then, in a case where the favorite operation is performed on the favorite icon FV superimposed and displayed on the image data, the processor 43 need only determine that the request for addition of the favorite information is performed on the image data, to add the favorite information to the image data.

In such a case, the processor 43 may change the first criterion or the second criterion based on the request for addition of the favorite information.

For example, the processor 43 obtains an average value of the scores of the respective image data to which the favorite information is added. The processor 43 sets a value obtained by subtracting a predetermined value from the average value as the score threshold value used for the first criterion. As a result, it is possible to display only the image data whose image quality is close to the image quality of the image data on which the favorite operation is performed on the display 44. As a result, it is possible to strictly select and display only the image data close to the preference of the user, and it is possible to effectively support the selection of the image data.

In a case where the favorite information is added to the image data of a certain group, the processor 43 may lower the similarity threshold value used as the second criterion such that the number of image data included in the group is increased. The processor 43 may increase the similarity threshold value used as the second criterion such that the number of image data included in the group to which the favorite information is not added is decreased. As a result, a large number of image data similar to the image data that the user likes are displayed in the third region 44C, and the selection of the image data can be effectively supported.

At least one of the first criterion or the second criterion may be changeable. For example, at least one of the first criterion or the second criterion may be changeable by an operation from the user. The change of the criterion includes one or both of changing the criterion itself or changing a threshold value (score threshold value or similarity threshold value) used to determine whether or not the criterion is satisfied.

The processor 43 may change at least one of the first criterion or the second criterion. For example, in a case where the number of image data included in the acquired image data group 50 is small, the number of image data included in the representative image data group 50B and the number of image data included in the image data group 50C tend to be decreased. Therefore, it is difficult for the user to search for the desired image data. On the other hand, in a case where the number of image data included in the acquired image data group 50 is large, the number of image data included in the representative image data group 50B and the number of image data included in the image data group 50C tend to be increased. Therefore, it is difficult for the user to search for the desired image data.

Therefore, the processor 43 changes the first criterion based on the number of image data included in the acquired image data group 50 such that the number of image data included in the representative image data group 50B falls within a predetermined range. Alternatively, the processor 43 changes the second criterion based on the number of image data included in the acquired image data group 50 such that the number of image data included in the image data group 50C falls within the predetermined range. As a result, it is possible to always display the same number of image data regardless of the number of image data included in the acquired image data group 50, and it is possible to improve the searchability of image data.

The processor 43 may receive a specific operation for the specific image data displayed in the second region 44B to perform a process corresponding to the specific operation. The specific operation includes an editing operation for editing the image data, such as changing the image quality or trimming. In a case where the specific operation is performed, the processor 43 edits the specific image data according to the specific operation. In a case where the specific image data is edited, there is a possibility that a change occurs in the degree of similarity between the specific image data and other image data of the group to which the specific image data belongs. Therefore, in this case, the similarity threshold value is changed such that the degree of similarity between other image data of the group to which the specific image data belongs and the specific image data is equal to or higher than the similarity threshold value. As a result, it is possible to prevent a situation in which the group to which the specific image data after editing belongs is different from the group to which the specific image data before editing belongs.

It is preferable that the processor 43 changes the image data displayed in the second region 44B to a display form distinguishable from the image data that is not displayed in the second region 44B. For example, the image data displayed in the second region 44B need only be grayed out and displayed, or a viewed mark need only be superimposed and displayed. Accordingly, the user can easily recognize the checked image data and the unchecked image data, and the efficiency of the work of selecting the image data can be enhanced.

As shown in FIG. 5, two or more of the plurality of selected image data may be selectable in a form in which the plurality of selected image data can be displayed in the second region 44B. In this case, the two or more selected image data, which are selected, are the specific image data. Then, the processor 43 selects the image data from the representative image data group 50B or the acquired image data group 50 based on the second criterion based on the two or more specific image data to obtain the image data group 50C. The second criterion based on the two or more specific image data is, for example, a criterion (hereinafter, referred to as a second criterion S2e) that the image data is the image data captured by an imaging apparatus 1 different from the imaging apparatus 1 that captures the two or more specific image data.

The second criterion based on the two or more specific image data may be a criterion of the degree of similarity with the two or more specific image data. For example, the second criterion may be a criterion that the degree of similarity is equal to or higher than the similarity threshold value for all of the two or more specific image data. As a result, the image data group 50C similar to all of the two or more specific image data can be displayed in the third region 44C. Alternatively, the second criterion based on the two or more specific image data may be a criterion that the degree of similarity is lower than the similarity threshold value for all of the two or more specific image data.

The type or the number of second criteria to be set may be changed according to the number of specific image data. For example, as shown in FIG. 5, in a case where only one of the representative image data g1 or the representative image data g2 displayed in the second region 44B is selected, the selected image data, which is selected, is the specific image data. In this case, the processor 43 generates the second criterion S2a or the image data group 50C satisfying the second criterion S2b.

On the other hand, in a case where both the representative image data g1 and the representative image data g2 displayed in the second region 44B are selected, the two selected image data, which are selected, are the specific image data. In this case, the processor 43 generates the image data group 50C satisfying the second criterion S2e. In this way, it is also possible to change the second criterion according to the number of selected image data to be selected, and to realize display of various image data according to the number of image data to be selected.

The processor 43 may display, in the first region 44A, the representative image data included in the representative image data group 50B in an order based on the first criterion. Specifically, the processor 43 displays, in the first region 44A, the representative image data included in the representative image data group 50B in descending order of the score. In a case where the acquired image data group 50 is updated and a new representative image data group 50B is generated, all of the representative image data included in the new representative image data group 50B are displayed in descending order of the score. That is, in a case where a score of old representative image data displayed before the update is lower than a score of the representative image data newly selected in the representative image data group 50B, the newly selected representative image data is preferentially displayed. For example, the newly selected representative image data can be displayed on an upper portion side of the first region 44A than the old representative image data. As a result, the image data with a high score is always displayed from the upper side of the first region 44A, and thus the efficiency of the work of selecting the image data by the user can be enhanced.

The processor 43 may perform control of changing the setting of the imaging apparatus 1 according to an operation from the user. Examples of the setting of the imaging apparatus 1 include exposure, white balance, a distance measurement area, a shutter speed, a focal length, and an imaging direction. For example, the processor 43 issues a command to the control apparatus that controls the imaging apparatus 1, through the network 2, and the control apparatus changes the setting of the imaging apparatus 1 according to the command. In this way, since the setting of the imaging apparatus 1 can be changed from the image viewing apparatus 4, the optimum setting can be changed according to the image data.

The processor 43 may omit the grouping process. In this case, the processor 43 need only display the image data group 50A in the first region 44A instead of the representative image data group 50B.

The display positions of the menu icon ME, the favorite icon FV, and the two dimensional code Cd are not limited to the example of FIG. 4, and for example, at least one of the menu icon ME, the favorite icon FV, or the two dimensional code Cd may be superimposed and displayed on the image data displayed in the second region 44B.

The processor of the image storage server 3 may execute a part of the process executed by the processor 43. For example, the first selection process may be performed by the processor of the image storage server 3. The first selection process and the grouping process may be performed by the processor of the image storage server 3. In this case, the processor of the display control apparatus is configured with the processor of the image storage server 3 and the processor 43.

For the specific image data, in addition to the favorite icon FV, a print icon for giving an instruction for printing or a save icon for giving an instruction for saving in an external device may be further displayed. In this case, in a case where the print icon is operated, the processor 43 executes a printing process of the specific image data, and adds the favorite information to the specific image data. In a case where the save icon is operated, the processor 43 executes a saving process of the specific image data, and adds the favorite information to the specific image data. As described above, the printing or the saving of the image data can be handled as the same operation as the favorite operation.

As described above, at least the following matters are described in the present specification.

(1)

A display control apparatus comprising: a processor; and a memory, in which the processor acquires a plurality of image data, performs control of displaying, in a first region of a display, a first image data group including a plurality of image data selected from the plurality of acquired image data based on a first criterion, performs control of displaying, in a second region of the display, selected image data that is at least one image data selected from the first image data group, and performs control of displaying, in a third region of the display, a second image data group including image data selected from the plurality of image data based on a second criterion based on specific image data that is at least one of the selected image data.

(2)

The display control apparatus according to (1), in which the first criterion is a criterion relating to an image quality.

(3)

The display control apparatus according to (1) or (2), in which the second criterion is a criterion relating to a degree of similarity with the specific image data.

(4)

The display control apparatus according to (1) or (2), in which the processor acquires the plurality of image data captured by a plurality of imaging apparatuses including a first imaging apparatus and a second imaging apparatus, and the second criterion is a criterion for determining whether or not image data is captured by the second imaging apparatus different from the first imaging apparatus that captures the specific image data in a predetermined period based on an imaging timing of the specific image data.

(5)

The display control apparatus according to (1) or (2), in which the second criterion is a criterion for determining whether or not image data shows the same subject as a subject included in the specific image data.

(6)

The display control apparatus according to (1) or (2), in which the processor acquires the plurality of image data captured by a plurality of imaging apparatuses including a first imaging apparatus and a second imaging apparatus, and the second criterion is a criterion for determining whether or not image data is captured by the second imaging apparatus different from the first imaging apparatus that captures the specific image data.

(7)

The display control apparatus according to any one of (1) to (6), in which the processor receives an operation on the specific image data to change the second criterion based on the received operation.

(8)

The display control apparatus according to any one of (1) to (7), in which the processor receives a request for addition of information for the image data displayed in any one of the first region, the second region, or the third region, and changes the first criterion or the second criterion based on the request for addition.

(9)

A display control apparatus comprising: a processor; and a memory, in which the processor acquires a plurality of image data, performs control of displaying, in a first region of a display, a first image data group including representative image data of each group obtained by grouping the plurality of acquired image data, performs control of displaying, in a second region of the display, selected image data that is at least one image data selected from the first image data group, and performs control of displaying, in a third region of the display, a second image data group that is image data of the group including specific image data that is at least one image data of the selected image data.

(10)

The display control apparatus according to (9), in which the processor further performs control of displaying, in the second region, image data selected from the second image data group displayed in the third region, receives a request for addition of information for the image data displayed in the second region, and replaces, in a case where the image data for which the request for addition is made does not match the representative image data included in the first image data group, the representative image data of the group including the image data for which the request for addition is made with the image data for which the request for addition is made.

(11)

The display control apparatus according to any one of (1) to (8), in which at least one of the first criterion or the second criterion is changeable.

(12)

The display control apparatus according to (11), in which the processor changes at least one of the first criterion or the second criterion based on the number of the acquired image data.

(13)

The display control apparatus according to any one of (1) to (12), in which the processor continuously acquires new image data to update at least one of the first image data group or the second image data group.

(14)

The display control apparatus according to (13), in which the processor performs, in a case where the new image data is included in the first image data group or the second image data group, control of displaying the new image data in a mode distinguishable from other image data.

(15)

The display control apparatus according to any one of (1) to (8), in which the processor displays, in the first region, the image data included in the first image data group in an order based on the first criterion.

(16)

The display control apparatus according to any one of (1) to (15), in which the processor further performs control of displaying, on the display, an acquisition image for acquiring the specific image data.

(17)

The display control apparatus according to any one of (1) to (16), in which the first region extends along a first direction, and the third region extends along a second direction intersecting the first direction.

(18)

The display control apparatus according to (17), in which a display size of the selected image data displayed in the second region is larger than a display size of each image data displayed in the first region and a display size of each image data displayed in the third region.

(19)

The display control apparatus according to (17) or (18), in which one side of the selected image data displayed in the second region matches the second direction.

(20)

The display control apparatus according to any one of (17) to (19), in which a longitudinal direction of a display region of the display matches the second direction.

(21)

The display control apparatus according to any one of (1) to (20), in which the processor changes the image data displayed in the second region to a display form distinguishable from image data that is not displayed in the second region.

(22)

The display control apparatus according to any one of (1) to (21), in which the processor further performs control of displaying, in the second region, image data selected from the second image data group.

(23)

The display control apparatus according to any one of (1) to (22), in which the processor acquires the plurality of image data from an imaging apparatus, and further performs control of changing a setting of the imaging apparatus.

(24)

A display control method comprising: acquiring a plurality of image data; performing control of displaying, in a first region of a display, a first image data group including a plurality of image data selected from the plurality of acquired image data based on a first criterion; performing control of displaying, in a second region of the display, selected image data that is at least one image data selected from the first image data group; and performing control of displaying, in a third region of the display, a second image data group including image data selected from the plurality of image data based on a second criterion based on specific image data that is at least one of the selected image data.

(25)

The display control method according to (24), in which the first criterion is a criterion relating to an image quality.

(26)

The display control method according to (24) or (25), in which the second criterion is a criterion relating to a degree of similarity with the specific image data.

(27)

The display control method according to (24) or (25), further comprising: acquiring the plurality of image data captured by a plurality of imaging apparatuses including a first imaging apparatus and a second imaging apparatus, in which the second criterion is a criterion for determining whether or not image data is captured by the second imaging apparatus different from the first imaging apparatus that captures the specific image data in a predetermined period based on an imaging timing of the specific image data.

(28)

The display control method according to (24) or (25), in which the second criterion is a criterion for determining whether or not image data shows the same subject as a subject included in the specific image data.

(29)

The display control method according to (24) or (25), further comprising: acquiring the plurality of image data captured by a plurality of imaging apparatuses including a first imaging apparatus and a second imaging apparatus, in which the second criterion is a criterion for determining whether or not image data is captured by the second imaging apparatus different from the first imaging apparatus that captures the specific image data.

(30)

The display control method according to any one of (24) to (29), further comprising: receiving an operation on the specific image data to change the second criterion based on the received operation.

(31)

The display control method according to any one of (24) to (30), further comprising: receiving a request for addition of information for the image data displayed in any one of the first region, the second region, or the third region, and changing the first criterion or the second criterion based on the request for addition.

(32)

A display control method comprising: acquiring a plurality of image data; performing control of displaying, in a first region of a display, a first image data group including representative image data of each group obtained by grouping the plurality of acquired image data; performing control of displaying, in a second region of the display, selected image data that is at least one image data selected from the first image data group; and performing control of displaying, in a third region of the display, a second image data group that is image data of the group including specific image data that is at least one image data of the selected image data.

(33)

The display control method according to (32), further comprising: performing control of displaying, in the second region, image data selected from the second image data group displayed in the third region; receiving a request for addition of information for the image data displayed in the second region; and replacing, in a case where the image data for which the request for addition is made does not match the representative image data included in the first image data group, the representative image data of the group including the image data for which the request for addition is made with the image data for which the request for addition is made.

(34)

The display control method according to any one of (24) to (31), in which at least one of the first criterion or the second criterion is changeable.

(35)

The display control method according to (34), further comprising: changing at least one of the first criterion or the second criterion based on the number of the plurality of acquired image data.

(36)

The display control method according to any one of (24) to (35), further comprising: continuously acquiring new image data to update at least one of the first image data group or the second image data group.

(37)

The display control method according to (36), further comprising: performing, in a case where the new image data is included in the first image data group or the second image data group, control of displaying the new image data in a mode distinguishable from other image data.

(38)

The display control method according to any one of (24) to (31), further comprising: displaying, in the first region, the image data included in the first image data group in an order based on the first criterion.

(39)

The display control method according to any one of (24) to (38), further comprising: performing control of displaying, on the display, an acquisition image for acquiring the specific image data.

(40)

The display control method according to any one of (24) to (39), in which the first region extends along a first direction, and the third region extends along a second direction intersecting the first direction.

(41)

The display control method according to (40), in which a display size of the selected image data displayed in the second region is larger than a display size of each image data displayed in the first region and a display size of each image data displayed in the third region.

(42)

The display control method according to (40) or (41), in which one side of the selected image data displayed in the second region matches the second direction.

(43)

The display control method according to any one of (40) to (42), in which a longitudinal direction of a display region of the display matches the second direction.

(44)

The display control method according to any one of (24) to (43), further comprising: changing the image data displayed in the second region to a display form distinguishable from image data that is not displayed in the second region.

(45)

The display control method according to any one of (24) to (44), further comprising: performing control of displaying, in the second region, image data selected from the second image data group.

(46)

The display control method according to any one of (24) to (45), further comprising: acquiring the plurality of image data from an imaging apparatus; and performing control of changing a setting of the imaging apparatus.

(47)

A display control program causing a processor to execute steps comprising: acquiring a plurality of image data; performing control of displaying, in a first region of a display, a first image data group including a plurality of image data selected from the plurality of acquired image data based on a first criterion; performing control of displaying, in a second region of the display, selected image data that is at least one image data selected from the first image data group; and performing control of displaying, in a third region of the display, a second image data group including image data selected from the plurality of image data based on a second criterion based on specific image data that is at least one of the selected image data.

(48)

A display control program causing a processor to execute steps comprising: acquiring a plurality of image data; performing control of displaying, in a first region of a display, a first image data group including representative image data of each group obtained by grouping the plurality of acquired image data; performing control of displaying, in a second region of the display, selected image data that is at least one image data selected from the first image data group; and performing control of displaying, in a third region of the display, a second image data group that is image data of the group including specific image data that is at least one image data of the selected image data.

### EXPLANATION OF REFERENCES

1a, 1b, 1c, 1: imaging apparatus
G1, G2, G3, G4, G5, G6, G7, G8: group
g1, g2, g3, g4: representative image data
2: network
3: image storage server
4: image viewing apparatus
40: display control apparatus
41: communication interface
42: memory
43: processor
44A: first region
44B: second region
44C: third region
44R: display region
44: display
50A, 50C: image data group
50B: representative image data group
50: acquired image data group
51: image data
100: image management system

What is claimed is:

1. A display control apparatus comprising:
a processor; and
a memory,
wherein the processor is configured to
acquire a plurality of image data,
perform control of displaying, in a first region of a display, a first image data group including a plurality of first image data selected from the plurality of acquired image data based on a first criterion,
perform control of displaying, in a second region of the display, selected image data that is at least one image data selected from the first image data group, and
perform control of displaying, in a third region of the display, a second image data group including second image data selected from the plurality of image data based on a second criterion based on specific image data that is at least one of the selected image data.

2. The display control apparatus according to claim 1,
wherein the first criterion is a criterion relating to an image quality.

3. The display control apparatus according to claim 1,
wherein the second criterion is a criterion relating to a degree of similarity with the specific image data.

4. The display control apparatus according to claim 1,
wherein the processor is configured to acquire the plurality of image data captured by a plurality of imaging apparatuses including a first imaging apparatus and a second imaging apparatus, and
the second criterion is a criterion for determining whether or not image data is captured by the second imaging apparatus different from the first imaging apparatus, that captures the specific image data, in a predetermined period based on an imaging timing of the specific image data.

5. The display control apparatus according to claim 1,
wherein the second criterion is a criterion for determining whether or not image data shows a same subject as a subject included in the specific image data.

6. The display control apparatus according to claim 1,
wherein the processor is configured to acquire the plurality of image data captured by a plurality of imaging apparatuses including a first imaging apparatus and a second imaging apparatus, and
the second criterion is a criterion for determining whether or not image data is captured by the second imaging apparatus different from the first imaging apparatus that captures the specific image data.

7. The display control apparatus according to claim 1,
wherein the processor is configured to receive an operation on the specific image data to change the second criterion based on the received operation.

8. The display control apparatus according to claim 1,
wherein the processor is configured to
receive a request for addition of information for the image data displayed in any one of the first region, the second region, or the third region, and
change the first criterion or the second criterion based on the request for addition.

9. The display control apparatus according to claim 1,
wherein at least one of the first criterion or the second criterion is changeable.

10. The display control apparatus according to claim 9,
wherein the processor is configured to change at least one of the first criterion or the second criterion based on number of the acquired image data.

11. The display control apparatus according to claim 1,
wherein the processor is configured to continuously acquire new image data to update at least one of the first image data group or the second image data group.

12. The display control apparatus according to claim 11,
wherein the processor is configured to perform, in a case where the new image data is included in the first image data group or the second image data group, control of displaying the new image data in a mode distinguishable from other image data.

13. The display control apparatus according to claim 1,
wherein the processor is configured to display, in the first region, the image data included in the first image data group in an order based on the first criterion.

14. The display control apparatus according to claim 1,
wherein the processor is configured to further perform control of displaying, on the display, an acquisition image for acquiring the specific image data.

15. The display control apparatus according to claim 1,
wherein the first region extends along a first direction, and the third region extends along a second direction intersecting the first direction.

16. The display control apparatus according to claim 15,
wherein a display size of the selected image data displayed in the second region is larger than a display size of each image data displayed in the first region and a display size of each image data displayed in the third region.

17. The display control apparatus according to claim 15,
wherein one side of the selected image data displayed in the second region matches the second direction.

18. The display control apparatus according to claim 15,
wherein a longitudinal direction of a display region of the display matches the second direction.

19. The display control apparatus according to claim 1,
wherein the processor is configured to change the image data displayed in the second region to a display form distinguishable from image data that is not displayed in the second region.

20. The display control apparatus according to claim 1,
wherein the processor is configured to further perform control of displaying, in the second region, image data selected from the second image data group.

21. The display control apparatus according to claim 1,
wherein the processor is configured to
acquire the plurality of image data from an imaging apparatus, and
further perform control of changing a setting of the imaging apparatus.

22. A display control method comprising:
acquiring a plurality of image data;
performing control of displaying, in a first region of a display, a first image data group including a plurality of first image data selected from the plurality of acquired image data based on a first criterion;
performing control of displaying, in a second region of the display, selected image data that is at least one image data selected from the first image data group; and
performing control of displaying, in a third region of the display, a second image data group including second image data selected from the plurality of image data based on a second criterion based on specific image data that is at least one of the selected image data.

23. A non-transitory computer readable medium storing a display control program causing a processor to execute steps comprising:
acquiring a plurality of image data;
performing control of displaying, in a first region of a display, a first image data group including a plurality of first image data selected from the plurality of acquired image data based on a first criterion;
performing control of displaying, in a second region of the display, selected image data that is at least one image data selected from the first image data group; and
performing control of displaying, in a third region of the display, a second image data group including second image data selected from the plurality of image data based on a second criterion based on specific image data that is at least one of the selected image data.
